(19) United States
(12) Patent Application Publication
(10) Pub. No.: US 2016/0132756 A1
(43) Pub. Date: May 12, 2016

(54) INFORMATION PROCESSING APPARATUS, CONTROL METHOD FOR INFORMATION PROCESSING APPARATUS, AND IMAGE FORMING SYSTEM

(71) Applicant: Konica Minolta, Inc., Tokyo (JP)

(72) Inventor: Tatsuro YAMAMURO, Kashiwa-shi (JP)

(73) Assignee: Konica Minolta, Inc., Tokyo (JP)

(21) Appl. No.: 14/933,643

(22) Filed: Nov. 5, 2015

(30) Foreign Application Priority Data
Nov. 6, 2014 (JP) 2014-226270

(51) Int. Cl. G06K 15/02; G06F 3/12

(52) U.S. Cl. CPC G06K 15/188; G06K 15/1823; G06F 3/1208; G06F 3/1243; G06F 3/1254

(57) ABSTRACT

An image forming apparatus includes a printing unit printing, on a printed matter on which a first color patch for color adjustment is printed, an image based on digital print data including a second color patch, and a measurement unit measuring the first and second color patches. An information processing apparatus adjusts color information for printing the image, based on a result of measurement of the first and second color patches measured by the measurement unit, and instructs the image forming apparatus to print the image based on the adjusted color information.

This application is based on Japanese Patent Application No. 2014-226270 filed with the Japan Patent Office on Nov. 6, 2014, the entire content of which is hereby incorporated by reference.

### BACKGROUND OF THE INVENTION

1. Field of the Invention

The present invention relates to an information processing apparatus, a control method for an information processing apparatus, and an image forming system.

2. Description of the Related Art

Image forming apparatuses such as printer, copier, multi function peripheral (MPP) having the color printing capability have become widespread. In the case where this image forming apparatus is used to perform color printing, color management is important for accurately reproducing colors included in a job. Then, conventionally a color patch placed on an edge of a printed matter is measured by an inline sensor provided in an image forming apparatus, and an information processing apparatus which controls the image forming apparatus compares color information extracted from the job with the color information read by the inline sensor to thereby determine the color variation therebetween, and performs feedback at any time so that the color variation falls within a proper range.

Regarding such feedback control, Japanese Laid-Open Patent Publication No. 2005-318478 discloses a configuration for managing colors of an image forming, apparatus, by placing color patches having different types of tone patterns on a peripheral margin of a sheet of paper alternately in a predetermined order and measuring the color patches.

### SUMMARY OF THE INVENTION

In the case where variable data is to be printed, there is a workflow of outputting a fixed portion through offset printing in advance and overprinting only a variable portion through digital printing.

In order to ensure the quality appropriate to the final printed matter of this workflow, it is not sufficient to merely manage colors of an image forming apparatus which performs digital printing.

In the case for example where a screen tint of offset printing and a screen tint of digital printing are of the same color and adjacent to each other but the color generated by offset printing and the color generated by digital printing appear to be significantly different from each other, a problem arises that the color continuity is lost.

The present disclosure is given to solve such a problem, and provides an information processing apparatus, a control method for an information processing apparatus, and an image forming system that are capable of properly managing colors when an image is printed on a printed matter.

In order to achieve at least one of the above-described objects, an information processing apparatus reflecting an aspect of the present disclosure controls an image forming apparatus which includes: a printing unit printing, on a printed matter on which a first color patch for color adjustment is printed, an image based on digital print data including a second color patch; and a measurement unit measuring the first and second color patches on the printed matter printed by the printing unit. The information processing apparatus includes: an adjustment unit adjusting color information for printing the image on the printed matter by the printing unit, based on a result of measurement of the first and second color patches measured by the measurement unit; and an instruction output unit instructing the image forming apparatus to print the image based on the color information adjusted by the adjustment unit.

Preferably, the adjustment unit makes a determination as to whether or not a color difference between the first and second color patches is less than a specified value.

Preferably, the adjustment unit adjusts a parameter of the color information based on a result of the determination.

Preferably, the information processing apparatus includes a color patch generation and placement unit generating, the second color patch included in the digital print data.

Preferably, the color patch generation and placement unit sets the second color patch at a position so that the second color patch does not overlap the first color patch printed on the printed matter.

Preferably, the color patch generation and placement unit sets, in accordance with an instruction, the second color patch at a position so that the second color patch does not overlap the first color patch printed on the printed matter.

Preferably, the information processing apparatus further includes an adjustment setting unit capable of setting, in accordance with an instruction, intervals at which the color information is adjusted based on a result of measurement of the first and second color patches on the printed matter,

Preferably, the information processing apparatus further includes an adjustment change setting unit instructing the adjustment unit, in accordance with an instruction, to adjust the color information based on a result of measurement of the second color patch on the printed matter.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a diagram illustrating a schematic configuration of a printing system 1 based on an embodiment.

FIG. 2 is a diagram illustrating print data FA based on an embodiment.

FIG. 3 is a diagram illustrating print data FB based on an embodiment.

FIG. 4 is a diagram illustrating a printed matter Q based on an embodiment,

FIG. 5 is a diagram illustrating a hardware configuration of printing system 1 based on an embodiment.

FIG. 6 is a flow diagram illustrating a color-patch measurement process of an image forming apparatus 20 based on an embodiment.

FIG. 7 is a flow diagram illustrating a color information adjustment process of information processing apparatus 10 based on an embodiment,

FIG. 8 is a diagram illustrating a screen for setting the position of a color patch based on an embodiment

FIG. 9 is a diagram illustrating a print setting screen based on an embodiment.

FIG. 10 is a diagram illustrating a hardware configuration of a printing system 1# based on a modification of the embodiment.

### DESCRIPTION OF THE PREFERRED EMBODIMENTS

Embodiments will hereinafter be described in detail with reference to the drawings. In the drawings, the same or corresponding parts are denoted by the same reference characters, and a description thereof will not be repeated.

[Overview of Printing System]

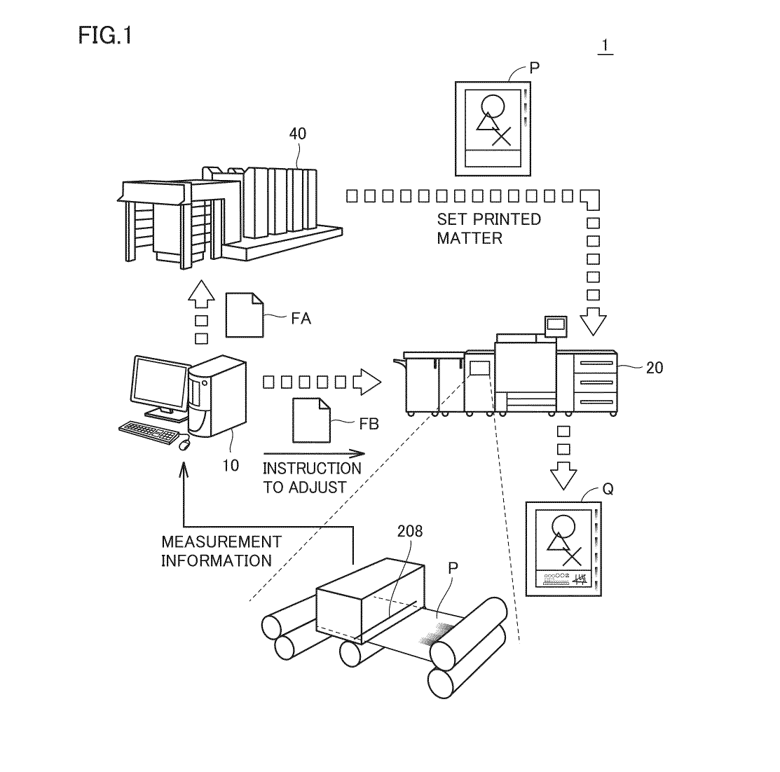

FIG. 1 is a diagram illustrating a schematic configuration of a printing system 1 based on an embodiment.

Referring to FIG. 1, printing system 1 includes an information processing apparatus 10 and image forming apparatuses 20, 40.

Information processing apparatus 10 is provided so that it is capable of communicating with each of image forming apparatuses 20, 40, and outputs, as a job, print instructions based on print data FA, FB to image forming apparatuses 20, 40, respectively.

Image forming apparatus 40 in this example is provided as an image forming apparatus performing, offset printing, by way of example. Image forming apparatus 20 is provided as an image forming apparatus performing digital printing.

Image forming apparatus 40 performs offset printing based on print data FA.

Image forming apparatus 20 performs digital printing based on print data FB, on a printed matter P generated through offset printing by image forming apparatus 40, namely performs so-called overprinting. In this example, a case is illustrated where image forming apparatus 20 outputs a final printed matter Q through digital printing.

In order to ensure the quality appropriate to final printed matter Q, it is necessary to keep within a certain value a difference in color between a printed portion of printed matter P generated through offset printing and a printed portion generated through digital printing on printed matter P.

With regard to this, offset printing causes density variations during output, and variations with time are large.

In view of the above, printing system 1 based on the embodiment adjusts colors to be printed through digital printing, so that they conform to printed matter P generated through offset printing.

In this example, printed color information is measured by an inline sensor 208 provided in image forming apparatus 20, by way of example.

Specifically, image forming apparatus 20 uses inline sensor 208 to measure each of a color patch (first color patch) printed on printed matter P by image forming apparatus 40 for the sake of color adjustment, and another color patch (second color patch) printed on printed matter P.

Image forming apparatus 20 transmits the results of the measurement to information processing apparatus 10.

Information processing apparatus 10 analyzes the results of the measurement to thereby adjust the color information. Specifically, for each object type (Image/Graphic/Text, for example) and for each color space (CMYK/RGB/Gray, for example), the tone curve, the color profile, and the like (parameters) are set, so that a color difference between the color patch (first color patch) for color adjustment printed by image forming apparatus 40 and the color patch (second color patch) for color adjustment printed by image forming apparatus 20 is less than a specified value,

Information processing apparatus 10 instructs image forming apparatus 20 to adjust the color information to the set color information.

Based on the color information which follows the instruction from information processing apparatus 10, image forming apparatus 20 performs digital printing.

[Description of. Print Data]

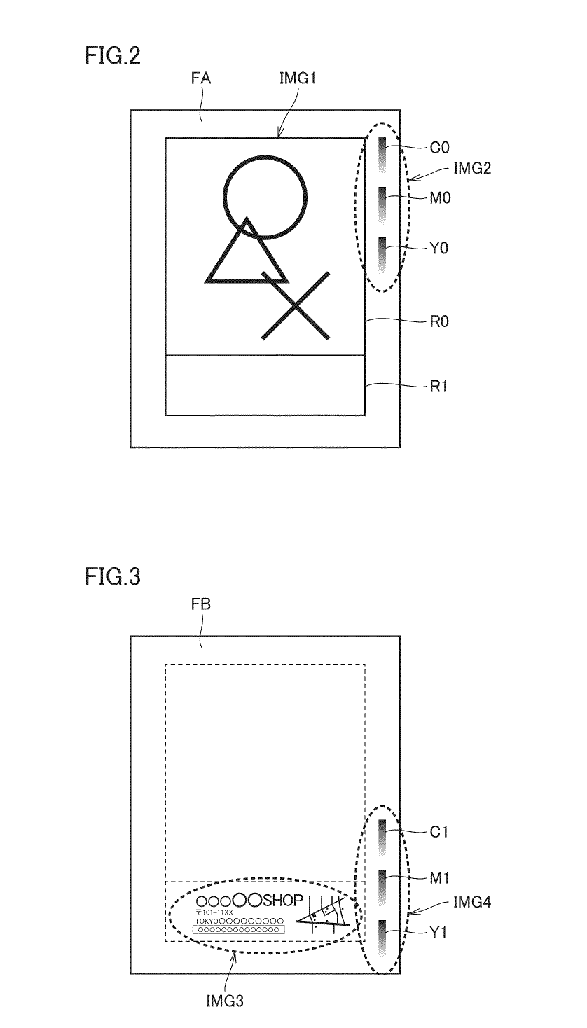

FIG. 2 is a diagram illustrating print data FA based on an embodiment.

As shown in FIG. 2, print data FA for offset printing includes an image IMG1 of “◯Δ×” and frame lines R0, R1, as well as an image IMG2 provided outside the frame lines.

In image IMG1, an image “◯Δ×” is indicated in the region enclosed by frame line R0. The region enclosed by frame line R1 is a blank region. By way of example, digital printing is performed within the blank region, which will be described later herein.

Image IMG2 is a color patch made up of cyan (C) C0, magenta (M) M0, and yellow (Y) Y0, and is formed so that the density continuously changes. Image IMG2 is set at a position in a margin region of a sheet of paper so that image IMG2 does not overlap image IMG1.

FIG. 3 is a diagram illustrating print data FB based on an embodiment.

As shown in FIG. 3, print data FB for digital printing is variable data for printing in the region enclosed by frame line R1 (see FIG. 2). In this example, this data includes an image IMG3 of “a character string and a map regarding an address” and an image IMG4 provided outside.

Image IMG3 is set so that the image of “a character string and a map regarding an address” is printed in the region enclosed by frame line R1.

Image IMG4 is a color patch made up of cyan (C) C1, magenta (M) M1, and yellow (Y) Y1, and is formed so that the density continuously changes. Image IMG4 is set at a position in a margin region of a sheet of paper so that image IMG4 does not overlap image IMG3.

[Description of Printed Matter]

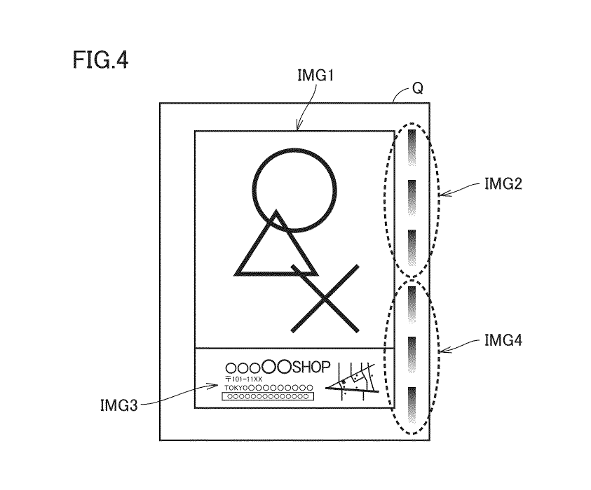

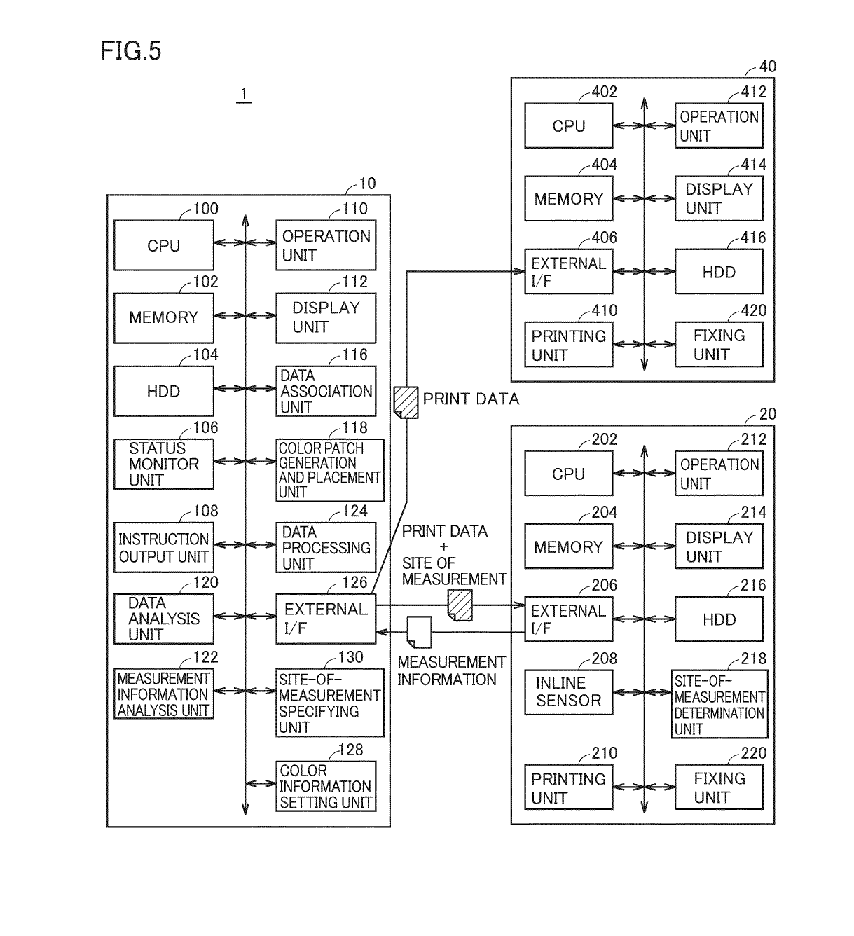

FIG. 4 is a diagram illustrating printed matter Q based on an embodiment,

As shown in FIG. 4, printed matter Q is a final printed matter generated through printing based on print data FB on printed matter P generated through printing by image forming apparatus 40 based on print data FA as described above.

On this printed matter Q, images IMG1 to IMG4 have been printed.

In the embodiment, in order to ensure the quality appropriate to final printed matter Q, the color information of the color patch of image IMG2 printed by image forming apparatus 40 and the color information of the color patch of image IMG4 printed by image forming apparatus 20 are measured by inline sensor 208, as described above. Then, image forming apparatus 20 transmits the results of the measurement to information processing apparatus 10. Information processing apparatus 10 analyzes the results of the measurement to thereby adjust the color information and outputs the results of the adjustment to image forming apparatus 20. Thus, in the case where a color difference derived from the results of the measurement by inline sensor 208 is a specified value or more, the adjustment can be made so that the color difference is less than the specified value. Specifically, parameters of the color information for printing by image forming apparatus 20 are adjusted so that the color information conforms to the color information of the color patch of image IMG2 measured by inline sensor 208.

[Hardware Configuration]

FIG. 5 is a diagram illustrating a hardware configuration of printing system 1 based on an embodiment.

As shown in FIG. 5, printing system 1 includes information processing apparatus 10 and image forming apparatuses 20, 40.

Information processing apparatus 10 includes a CPU (Central Processing Unit) 100, a memory 102, an HDD (Hard Disk Drive) 104, a status monitor unit 106, an instruction output unit 108, an operation unit 110, a display unit 112, a data association unit 116, a color patch generation and placement unit 118, a data analysis unit 120, a measurement information analysis unit 122, a data processing unit 124, an external I/F 126, a color information setting unit 128, and a site-of-measurement specifying unit 130.

CPU 100 and memory 102 such as a ROM (Read Only Memory) and a RAM (Random Access Memory) for example constitute a control unit.

The ROM stores a control program and data necessary for control. The RAM is used as a working area for data necessary for control by CPU 100 and as a working area when the control operation is done, and stores data and the like that require temporary storage. CPU 100 cooperates with the ROM and the RAM to control the overall operation of information processing apparatus 10.

HDD 104 stores job data and image data, color information and position (coordinates) information derived from the image data, and image data with color patches, and the like.

Status monitor unit 106 monitors the job status or the like, and the states of image forming apparatuses 20, 40.

Operation unit 110 receives user's instructions or operation via a mouth and/or a keyboard, or a touch panel, or the like.

Display unit 112 is formed of an LCD (Liquid Crystal Display) or the like and enables various forms of display regarding printing.

Data processing unit 124 analyzes the job data stored in HDD 104 or job data obtained from a client connected to a communication network, and performs rasterization to thereby generate image data.

Data analysis unit 120 analyzes the image data and extracts each object (Image/Graphic/Text) of the job, color information of each color space (CMYK/RGB/Gray), and position (coordinates) information.

Color patch generation and placement unit 118 generates a color patch corresponding to the color information and places the generated color patch at a predetermined location (such as a periphery of an image of the page). Further, following an instruction, color patch generation and placement unit 118 changes the location of the color patch.

Site-of-measurement specifying unit 130 specifies a position of measurement in image data with a color patch that is to be measured by image forming apparatuses 20, 40. Site-of-measurement specifying unit 130 specifies the position of measurement for image forming apparatus 20 to measure the color information of the color patches of image IMG2 and image IMG4. Site-of-measurement specifying unit 130 specifies the position of measurement for image forming apparatus 40 to measure the color information of the color patch of image IMG2.

Data association unit 116 associates image data with other data or the like. For example, data association unit 116 associates an image of a color patch with information about a position of measurement indicating a site of measurement specified by site-of-measurement specifying unit 130.

External I/F 126 is constituted of an NIC (Network Interface Card) and/or a modem for example, and transmits to image forming apparatuses 20, 40 image data with color patches and information about a specified position-of-measurement, for example.

Measurement information analysis unit 122 analyzes the measurement information regarding the measurement made by inline sensor 208 that is received via external I/F 126 from image forming apparatus 20. Specifically, measurement information analysis unit 122 compares the information about measurement of the color patch (first color patch) for color adjustment printed by image forming apparatus 40, with the information about measurement of the color patch (second color patch) for color adjustment printed by image forming apparatus 20, and then determines whether or not a color difference (color variation) of the same color is larger than a predetermined threshold value. In the case where the color variation is larger than the threshold value, the set information of color information setting unit 128 is rewritten depending on the color variation.

Color information setting unit 128 sets, for each object type and for each color space, the tone curve, the color profile, and the like (parameters),

Instruction output unit 108 instructs image forming apparatus 20 to execute a predetermined command, following an instruction from CPU 100. For example, instruction output unit 108 outputs to image forming apparatus 20 an instruction to change color information to the color information set by color information setting unit 128.

While status monitor unit 106, instruction output unit 108, data association unit 116, color patch generation and placement unit 118, data analysis unit 120, measurement information analysis unit 122, data processing unit 124, color information setting unit 128, and site-of-measurement specifying unit 130 for example are implemented in the form of hardware in this example, these functions may also be implemented by a control program operated by the control unit.

Image forming apparatus 20 includes a CPU 202, a memory 204, an external I/F 206, an inline sensor 208, a printing unit 210, an operation unit 212, a display unit 214, an HDD 216, a site-of-measurement determination unit 218, and a fixing unit 220.

CPU 202 and memory 204 such as a ROM (Read Only Memory) and a RAM (Random Access Memory) for example constitute a control unit.

The ROM stores a control program and data necessary for control. The RAM stores data necessary for control by CPU 202 and data or the like that requires temporary storage when a control operation is done. CPU 202 cooperates with the ROM and the RAM to control the overall operation of image forming apparatus 20.

HDD 216 stores image data with color patches and the information about the position of measurement indicating the location where the color value is to be measured, for example, that are transmitted from information processing apparatus 10.

Operation unit 212 receives user's instructions or operation via a mouth and/or a keyboard, or a touch panel, or the like.

Display unit 214 is formed of an LCD (Liquid Crystal Display) or the like and enables various forms of display regarding printing.

External I/F 206 is constituted of an NIC (Network Interface Card) and/or a modem for example, receives from information processing apparatus 10 image data with color patches (print data), and also transmits to information processing apparatus 10 information about measurement derived from measurement of a color value by inline sensor 208.

Printing unit 210 follows an electrophotography process to form an image on a sheet of paper, based on the image data with color patches that is received from information processing apparatus 10. Specifically, printing unit 210 includes: a writing unit applying a laser beam to perform exposure based on the image data; a photoconductor unit which includes a photoconductor drum, a developing device, a charging device, a photoconductor cleaning unit, and a primary transfer roller, for forming a toner image of each color of CMYK; an intermediate transfer belt rotated by rollers to function as an intermediate transfer unit transporting the toner image formed by the photoconductor unit to a sheet of paper; a secondary transfer roller transferring the toner image formed on the intermediate transfer belt to the sheet of paper; a fixing device fixing the toner image transferred to the sheet of paper; and a transport unit such as a paper feed roller and a registration roller for transporting a sheet of paper, a loop roller, a reverse roller, a paper discharge roller, and the like.

Inline sensor 208 is made up of three different sensors for RGB for example that are provided on a sheet transport path between the fixing device and a paper discharge tray, measures color values based on output values (RGB values) from the three different sensors for each part of a color image, and outputs information about the measurement.

Site-of-measurement determination unit 218 determines the site where the color value is to be measured, based on the information about the position of measurement that is transmitted from information processing apparatus 10, and instructs inline sensor 208 to measure the color values.

While site-of-measurement determination unit 218 and the like are configured in the form of hardware in this example, the functions may also be implemented by a control program operated by the control unit.

Image forming apparatus 40 includes a CPU 402, a memory 404, an external I/F 406, a printing unit 410, an operation unit 412, a display unit 414, an HDD 416, and a fixing unit 420.

While Image forming apparatus 40 differs from image forming apparatus 20 in that the former is not mounted with the inline sensor and the site-of-measurement determination unit, other functions of image forming apparatus 40 are basically identical to those implemented by the hardware of image forming apparatus 20. The detailed description of the functions of image forming apparatus 40 will therefore not be given.

[Process Flow of Image Forming Apparatus 20]

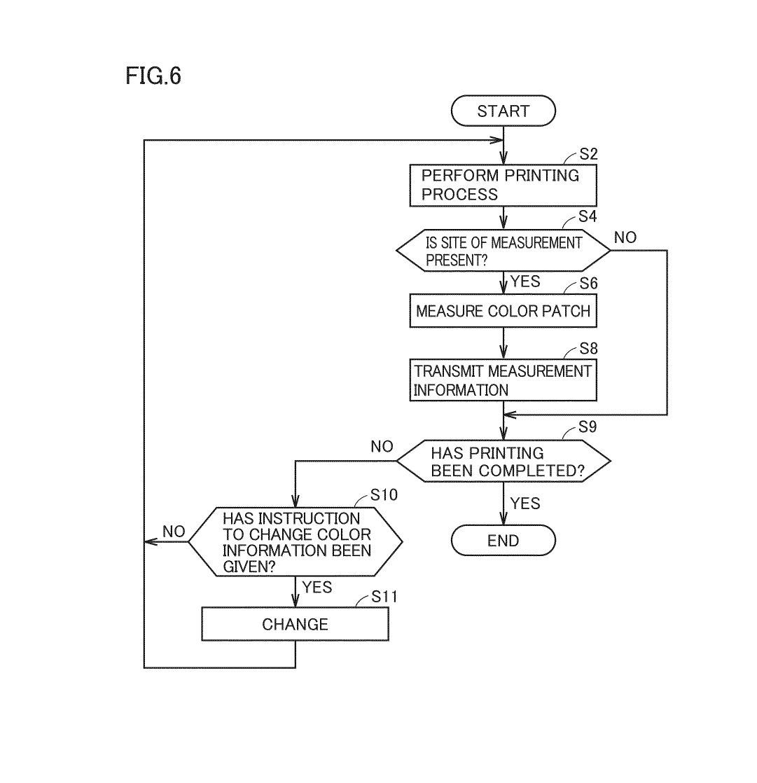

FIG. 6 is a flow diagram illustrating a color-patch measurement process of image forming apparatus 20 based on an embodiment.

As shown in FIG. 6, image forming apparatus 20 performs a printing process (step S2). Specifically, image forming apparatus 20 receives, via external I/F 206, print data and information about a site of measurement, and printing unit 210 prints, based on the received print data FB, an image on printed matter P generated through printing by image forming apparatus 40.

Next, image forming apparatus 20 determines whether or not a site of measurement is present (step S4). Specifically, site-of-measurement determination unit 218 determines whether or not information about a site of measurement (information about a position of measurement) is present.

Next, in the case where image forming apparatus 20 determines that a site of measurement is present (YES in step S4), it measures a color patch (step S6). Specifically, in the case where site-of-measurement determination unit 218 determines that information about a position of measurement is present, it instructs inline sensor 208 to measure the specified site. In this example, inline sensor 208 measures color values of the color patch of image IMG2 and the color patch of image IMG4 of printed matter Q.

Next, image forming apparatus 20 transmits the information measured by inline sensor 208 to information processing apparatus 10 (step S8). Specifically, CPU 202 outputs the information about the measurement made by inline sensor 208 to information processing apparatus 10 via external I/F 206.

Next, image forming apparatus 20 determines whether or not printing has been completed (step S9). Specifically, CPU 202 determines whether or not the print job has been completed (printing on a specified number of sheets of paper has been completed).

In the case where image forming apparatus 20 determines in step S9 that printing has been completed (YES in step S9), it ends the process. Specifically, in the case where image forming apparatus 20 determines that the print job has been completed (printing on a specified number of sheets of paper has been completed), it ends the process.

In contrast, in the case where image forming apparatus 20 determines in step S9 that printing has not been completed (NO in step S9), it determines whether or not an instruction to change color information has been given (step S10). Specifically, in the case where CPU 202 determines that the print job has not been completed (printing on a specified number of sheets of paper has not been completed), it determines whether or not an instruction to change color information has been received via external I/F 206.

In the case where image forming apparatus 20 determines in step S10 that an instruction to change color information has been given (YES in step S10), it changes setting (step S11). Specifically, in the case where CPU 202 has received an instruction to change color information which is input via external I/F 206, it instructs printing unit 210 to perform printing following the instruction to change.

Returning to step S2, image forming apparatus 20 performs printing based on the adjusted color information. Specifically, based on print data FB, printing unit 210 prints, on printed matter P generated through printing by image forming apparatus 40, an image in accordance with the adjusted color information.

In contrast, in the case where image forming apparatus 20 determines in step S10 that an instruction to change color information has not been given (NO in step S10), it returns to step S2 and performs a printing process similar to the preceding one Specifically, based on print data FB, printing unit 210 prints, on printed matter P generated through printing by image forming apparatus 40, an image in accordance with color information similar to the preceding one.

In contrast, in the case where image forming apparatus 20 determines in step S4 that a site of measurement is not present (NO in step S4), it skips steps S6 and S8 and proceeds to step S9. The following process is similar to the above-described one.

[Process Flow of Information Processing Apparatus]

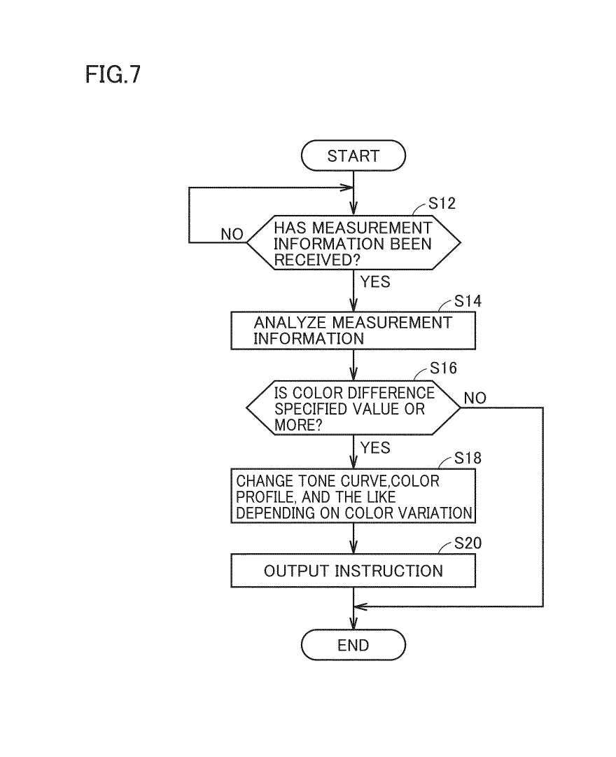

FIG. 7 is a flow diagram illustrating a color information adjustment process of information processing apparatus 10 based on an embodiment. Here, a description is mainly given of the color information adjustment process for image forming apparatus 20.

As shown in FIG. 7, information processing apparatus 10 determines whether or not it has received information about measurement from the image forming apparatus (step S12). Specifically, measurement information analysis unit 122 determines whether or not it has received information about measurement from, image forming apparatus 20 via external I/F 126.

In step S12, in the case where information processing apparatus 10 has not received information about measurement (NO in step S12), it maintains the current condition.

In the case where information processing apparatus 10 determines in step S12 that it has received information about measurement (YES in step S12), it analyzes the information about measurement (step S14). Specifically, measurement information analysis unit 122 compares information about measurement of the color patch (first color patch) for color adjustment that is printed by image forming apparatus 40, with information about measurement of the color patch (second color patch) for color adjustment that is printed by image forming apparatus 20. For example, it compares cyan C0 with cyan C1 of respective color patches to thereby obtain a difference in color value (color difference).

Then, information processing apparatus 10 determines whether or not the color difference is a specified value or more (step S16). Specifically, measurement information analysis unit 122 determines whether or not the color difference is a predetermined specified value or more. The specified value may be set as appropriate,

In the case where information processing apparatus 10 determines in step S16 that the color difference is the specified value or more (YES in step S16), it changes the tone curve, the color profile, and the like (parameters) depending on the color variation (step S18). Specifically, in the case where measurement information analysis unit 122 determines that the color difference is the specified value or more, it instructs color information setting unit 128 to change, depending on the color variation, the tone curve, the color profile, and the like (parameters) for image forming apparatus 20 which have been set by color information setting unit 128. The tone curve, the color profile, and the like (parameters) are changed so that the color difference is less than the specified value.

Then, information processing apparatus 10 outputs an instruction (step S20). Specifically, instruction output unit 108 outputs the changed color information to image forming apparatus 20. Image forming apparatus 20 performs a printing process based on the adjusted color information,

Then, information processing apparatus 10 ends the process (END).

In contrast, in the case where information processing apparatus 10 determines in step S16 that the color difference is not the specified value or more (NO in step S16), it directly ends the process (END). Specifically, measurement information analysis unit 122 ends the process without giving an instruction to change to color information setting unit 128.

The adjustment of the color information based on the information about measurement given from image forming apparatus 20 makes it possible to keep at a certain value the difference in color between a printed portion of a printed matter generated through offset printing and a printed portion generated through digital printing, and accordingly ensure the quality appropriate to the final printed matter. While the foregoing description of the present example is about the system of properly managing colors, for a printed matter generated through offset printing, the system is not limited particularly to offset printing and is applicable as well to other types of printed matters,

It should be noted that while the forgoing description of the present example is about color patches made up of cyan (C), magenta (M), and yellow (Y), the color patches are not particularly limited to this, and may be color patches made up of a plurality of colors such as a color patch made up of cyan (C), magenta (M), yellow (Y), and black (K), or a color patch of a single color only.

[Change of Color Patch Position]

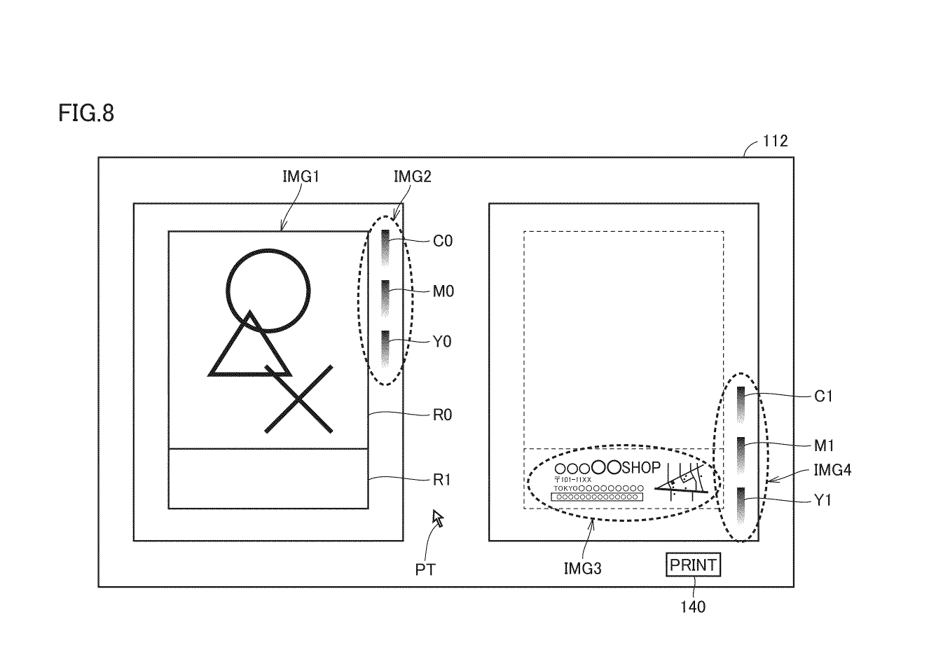

FIG. 8 is a diagram illustrating a screen for setting, the position of a color patch based on an embodiment.

As shown in FIG. 8, display unit 112 of information processing apparatus 10 indicates an edit screen based on print data FA and FB.

It is supposed that a variety of settings and changes can be made on the edit screen. On this edit screen, respective objects of print data FA and FB generated by data processing unit 124 are indicated. On the left section, image data based on print data FA is indicated. On the right section, image data based on print data FB is indicated.

On display unit 112, a “print” button 140 is provided, and selection of this “print” button 140 causes a print setting screen described later herein to be displayed.

As described above, data analysis unit 120 analyzes image data to extract each of objects (images IMG1 to IMG4) of a job as well as the color information and the position (coordinates) information of the objects.

Color patch generation and placement unit 118 generates a color patch corresponding to the color information and places the generated color patch at a predetermined location (such as a periphery of an image of the page).

Color patch generation and placement unit 118 generates an object (image IMG4) based on the position (coordinates) information about the aforementioned object (image IMG2) extracted by data analysis unit 120, and places the generated object so that this object does not overlap the aforementioned object (image IMG2). Moreover, the object (image IMG4) is placed at a position in a margin region of a sheet of paper that also does not overlap image IMG3.

This process makes it possible to properly measure the color patches by inline sensor 208 of image forming apparatus 20, and to properly perform color management based on the result of the measurement, and accordingly makes it possible to ensure the quality appropriate to the final printed matter.

In this example, a pointer PT is provided on display unit 112, and this pointer PT can be used to select image IMG4 to change the position of this image to any position as appropriate.

Color patch generation and placement unit 118 places the image at the changed position, and the position where the image is placed is specified as a position of measurement. Then, information about the position of measurement is transmitted together with image data.

The position of the color patch is allowed to be changed to any position as appropriate in accordance with a user's instruction, and accordingly the degree of freedom of editing of image data as intended by the user is improved.

[Print Setting Screen]

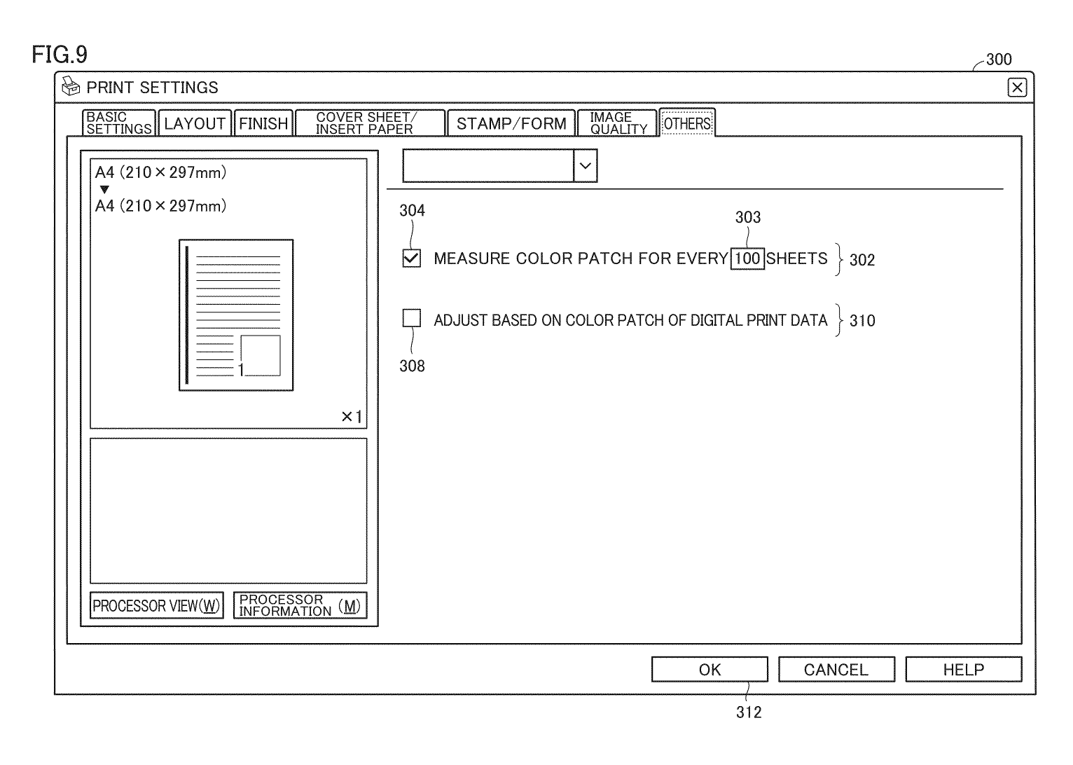

FIG. 9 is a diagram illustrating a print setting screen based on an embodiment.

As shown in FIG. 9, display unit 112 of information processing apparatus 10 indicates a print setting screen 300, by way of example. Specifically, selection of “print” button 140 on the aforementioned edit screen causes a print setting screen to be displayed with which the print setting can be done.

On this print setting screen, a plurality of tabs are provided. In this example, selection of “others” tab enables execution of a predetermined function to be selected.

Specifically, an item of a function of setting intervals at which a color patch is measured (adjustment setting unit), and an item of a function of making an adjustment based on a color patch for digital print data (adjustment change setting unit) are provided, and they are provided so that each can be selected.

For each item of the function, a checkbox is provided, and a check mark placed in the checkbox sets the function effective.

In this example, the item of the function of adjusting the intervals at which a color patch is measured, and the item of the function of making an adjustment based on a color patch for digital print data are provided so that each can be selected.

For each item of the function, a checkbox is provided, and a check mark placed in the checkbox sets the function effective.

Specifically, a checkbox 304 associated with the item of the function of adjusting the intervals at which a color patch is measured, and a checkbox 308 associated with the item of the function of making an adjustment based on a color patch for digital print data are provided.

In this example, a case is shown by way of example where a check mark is placed in checkbox 304 and “100” is input in an input box 303 provided for this item. Input to input box 303 can be done through a keyboard or the like,

Specifically, in this example, the function of measuring a color patch for every 100 sheets of paper is set effective.

Accordingly, image forming apparatus 20 measures, based on the command set on the print setting screen, color values of the color patch for every 100 sheets of paper, by means of inline sensor 208. Then, the information about the measurement is transmitted to information processing apparatus 10. Thus, the process of adjusting the color information is performed for every 100 sheets of paper.

The input to input box 303 enables a user to make an adjustment of the color information for every certain number of sheets of paper. Therefore, in the case for example where a change in density or a change with time relative to a printed matter generated through offset printing is small, a relatively large number can be input to input box 303 to thereby reduce useless adjustment, communication, and the like. On the contrary, in the case for example where a change in density or a change with time relative to a printed matter generated through offset printing is large, a relatively small number can be input to input box 303 to thereby properly manage the colors and keep generating a final printed matter of high quality.

Further, a check mark placed in checkbox 308 sets effective the function of making an adjustment based on a color patch for digital print data.

In accordance with the setting, what is to be measured is changed, and accordingly only a color patch (second color patch) for color adjustment that is printed by image forming apparatus 20 is to be measured.

In the case where measurement information analysis unit 122 receives information about the measurement from image forming apparatus 20, it compares the information about the measurement of the color patch (second color patch) for color adjustment that is printed by image forming apparatus 20, with reference information to be compared therewith. For example, the reference information to be compared may be information about measurement of first printed matter Q. The information about the measurement of the color patch printed on the first printed matter Q is then used as a reference, this reference is compared with information about measurement of a color patch of a printed matter after multiple sheets of paper have been printed, and accordingly a difference in color value (color difference) is obtained.

Then, in the case where measurement information analysis unit 122 determines that the color difference is a specified value or more, it instructs color information setting unit 128 to change, depending on the color variation, the tone curve, the color profile, and the like (parameters) for image forming apparatus 20 which have been set by color information setting unit 128. The tone curve, the color profile, and the like (parameters) are changed so that the color difference is less than the specified value. Then, instruction output unit 108 outputs the changed color information to image forming apparatus 20. Based on print data FB, image forming apparatus 20 prints an image in accordance with the adjusted color information.

Accordingly, based on the color patch (second color patch) for color adjustment that is printed by image forming apparatus 20, the color variation of the printed portion generated through digital printing can be suppressed and colors can properly be managed to thereby ensure the quality appropriate to the final printed matter.

<Modification>

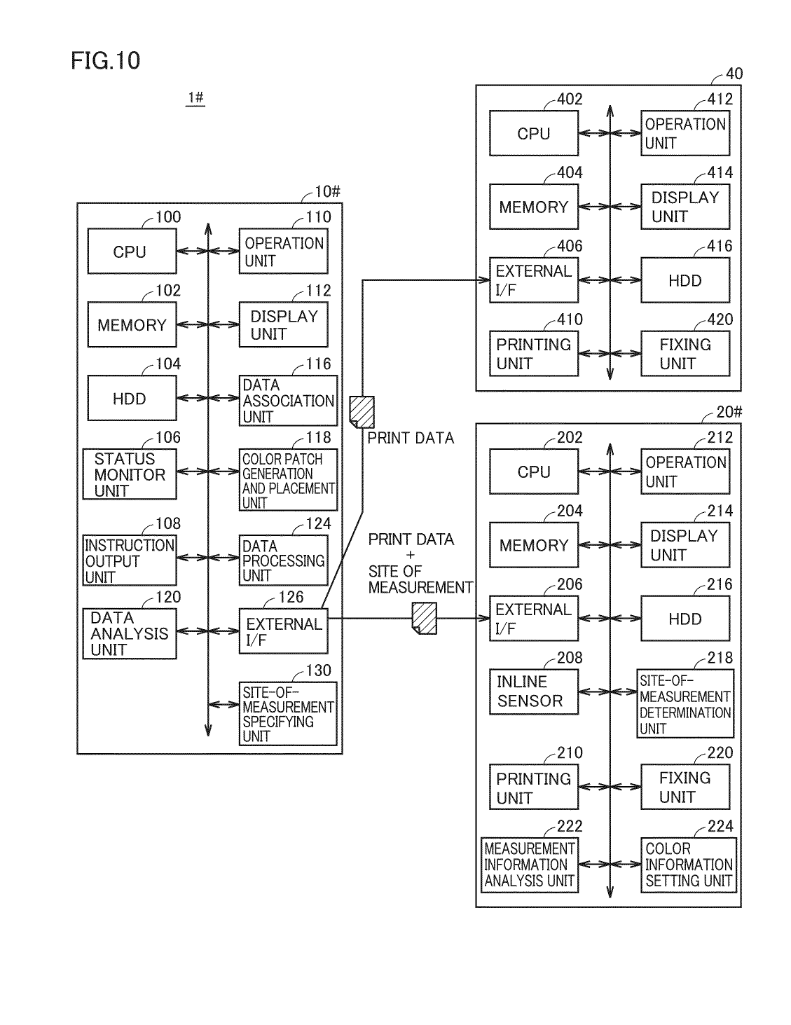

FIG. 10 is a diagram illustrating a hardware configuration of a printing system 1# based on a modification of the embodiment.

As shown in FIG. 10, printing system 1# differs from printing system 1 in that the former includes an information processing apparatus 10# instead of information processing apparatus 10, and an image forming apparatus 20# instead of image forming apparatus 20. The remaining components are similar to those described above.

Information processing apparatus 10# differs from information processing apparatus 10 in that the former does not include measurement information analysis unit 122 and color information setting unit 128.

Image forming apparatus 20# differs from image forming apparatus 20 in that the former additionally includes a measurement information analysis unit 222 and a color information setting unit 224.

The remaining components are similar to the above-described ones, and therefore, the detailed description thereof will not be repeated.

Image forming apparatus 20# based on the modification of the embodiment is configured to have respective functions of the measurement information analysis unit and the color information setting unit that are of information processing apparatus 10.

Specifically, measurement information analysis unit 222 analyzes the measurement information regarding the measurement made by inline sensor 208. Specifically, measurement information analysis unit 222 compares the information about measurement of the color patch (first color patch) for color adjustment printed by image forming apparatus 40, with the information about measurement of the color patch (second color patch) for color adjustment printed by image forming apparatus 20, and then determines whether or not a color difference (color variation) of the same color is larger than a predetermined threshold value. In the case where the color variation is larger than the threshold value, the set information of color information setting unit 224 is rewritten depending on the color variation.

Color information setting unit 224 sets, for each object type and for each color space, the tone curve, the color profile, and the like (parameters).

In printing system 1# based on the modification, image forming apparatus 20# determines whether or not a site of measurement is present. In the case where image forming apparatus 20# determines that a site of measurement is present, it measures the color patch.

Then, measurement information analysis unit 222 analyzes the information about measurement made by inline sensor 208. In the case where measurement information analysis unit 222 determines that the color difference is a specified value or more, it instructs color information setting unit 224 to change, depending on the color variation, the tone curve, the color profile, and the like (parameters) for image forming apparatus 20# which have been set by color information setting unit 224. The tone curve, the color profile, and the like (parameters) are changed so that the color difference is less than the specified value.

In image forming apparatus 20#, the color information is adjusted based on the information about measurement. Accordingly, a difference between a printed portion of a printed matter generated through offset printing and a printed portion generated through digital printing can be kept at a certain value, and the quality appropriate to the final printed matter can be ensured.

Thus, the color information can be adjusted in image funning apparatus 20# to thereby reduce the load of communication between information processing apparatus 10# and image forming apparatus 20#, and speedily make the adjustment. While the present example has been described regarding the configuration where measurement information analysis unit 222 and color information setting unit 224 are provided in image forming apparatus 20#, a part of them may be provided in information processing apparatus 10#.

Although the present invention has been described and illustrated in detail, it is clearly understood that the same is by way of illustration and example only and is not to be taken by way of limitation, the scope of the present invention being, interpreted by the terms of the appended claims.

What is claimed is:

1. An information processing apparatus controlling an image forming apparatus including:
a printing unit printing, on a printed matter on which a first color patch for color adjustment is printed, an image based on digital print data including a second color patch; and
a measurement unit measuring said first and second color patches on said printed matter printed by said printing unit,
said information processing apparatus comprising:
an adjustment unit adjusting color information for printing said image on said printed matter by said printing unit, based on a result of measurement of said first and second color patches measured by said measurement unit; and
an instruction output unit instructing said image forming apparatus to print said image based on the color information adjusted by said adjustment unit.

2. The information processing apparatus according to claim 1, wherein said adjustment unit makes a determination as to whether or not a color difference between said first and second color patches is less than a specified value.

3. The information processing apparatus according to claim 2, wherein said adjustment unit adjusts a parameter of said color information based on a result of the determination.

4. The information processing apparatus according to claim 1, comprising a color patch generation and placement unit generating said second color patch included in the digital print data.

5. The information processing apparatus according to claim 4, wherein said color patch generation and placement unit sets said second color patch at a position so that said second color patch does not overlap said first color patch printed on said printed matter.

6. The information processing apparatus according to claim 5, wherein said color patch generation and placement unit sets, in accordance with an instruction, said second color patch at a position so that said second color patch does not overlap said first color patch printed on said printed matter.

7. The information processing apparatus according to claim 1, further comprising an adjustment setting unit capable of setting, in accordance with an instruction, intervals at which the color information is adjusted based on a result of measurement of said first and second color patches on said printed matter.

8. The information processing apparatus according to claim 1, further comprising an adjustment change setting unit instructing said adjustment unit, in accordance with an instruction, to adjust said color information based on a result of measurement of said second color patch on said printed matter.

9. A control method for an information processing apparatus controlling an image forming apparatus including:
a printing unit printing, on a printed matter on which a first color patch for color adjustment is printed, an image based on digital print data including a second color patch; and
a measurement unit measuring said first and second color patches on said printed matter printed by said printing unit,
said control method comprising the steps of:
adjusting color information for printing said image on said printed matter by said printing unit, based on a result of measurement of said first and second color patches measured by said measurement unit; and
instructing said image forming apparatus to print said image based on the adjusted color information.

10. An image forming system comprising:
a printing unit printing, on a printed matter on which a first color patch for color adjustment is printed, an image based on digital print data including a second color patch;
a measurement unit measuring said first and second color patches on said printed matter printed by said printing unit; and
an adjustment unit adjusting colors for printing said image on said printed matter by said printing unit, based on a result of measurement of said first and second color patches measured by said measurement unit.
